(19) United States
(12) Patent Application Publication
(10) Pub. No.: US 2014/0335989 A1
(43) Pub. Date: Nov. 13, 2014

(54) MACHINE TOOL HAVING A DEVICE FOR SWITCHING BETWEEN A FIRST AND A SECOND TRANSMISSION STAGE BY REVERSING THE DIRECTION OF ROTATION

(71) Applicant: Hilti Aktiengesellschaft, Schaan (LI)

(72) Inventors: Josef Schittl, Thueringen (AT); Peter Brugger, Feldkirch (AT)

(21) Appl. No.: 14/367,572

(22) PCT Filed: Dec. 21, 2012
(86) PCT No.: PCT/EP2012/076615

§ 371 Date: Jun. 20, 2014

(30) Foreign Application Priority Data
Dec. 23, 2011 (DE) 10 2011 089 771.2

(51) Int. Cl. B23Q 5/14; F16H 3/44

(52) U.S. Cl. CPC B23Q 5/142; F16H 3/44
USPC 475/151

(57) ABSTRACT

A machine tool, including a drive unit with a drive motor and a drive shaft that can be rotated around a drive axis of rotation by the drive motor in a forward direction as well as in a reverse direction opposite to the forward direction, a driven unit with a driven shaft that can be non-rotatably connected to a processing tool and that can be rotated in a direction of rotation around a driven axis of rotation, a planetary gear train arranged between the drive shaft and the driven shaft, including several components, whereby the drive shaft is non-rotatably coupled to a first planetary gear component, and including a device for switching between a first and a second transmission stage of the planetary gear train by changing the direction of rotation of the drive unit.

The present invention relates to a machine tool having a device for switching between a first and a second transmission stage.

The term “machine tool” as set forth in the present invention encompasses all machine tools that drive a processing tool in only one direction during the machining. Typical examples are a wall saw, a coring tool and a hammer drill.

### BACKGROUND

When work is being performed with machine tools, the various substrates that are to be machined such as, for instance, wood, brick, reinforced concrete and non-reinforced concrete, call for the selection of the right processing tool as well as for the selection of machining parameters for the machine tool that are appropriate for the processing tool and for the substrate. For example, if reinforced concrete is being machined at a high rotational speed and at a high torque, the steel of the rebar causes a great deal of wear and tear on the tool, which drastically reduces the service life of the processing tool. The selection of the machining parameters depends, among other things, on the machine tool and differs, for example, for wall saws, coring tools or hammer drills. The relevant machining parameters for wall saws and coring tools include, for instance, the torque and the speed with which the processing tool is driven around the axis of rotation. In the case of hammer drills, for example, the travel angle of the striking mechanism is changed as a function of the substrate that is to be machined. Different rotational speeds, torques, travel angles or other appropriate machining parameters can be implemented by means of different gear ratios. Mechanical switching devices that are manually actuated by the operator are known for switching between a first and a second transmission stage.

Prior-art wall saws are operated with saw blades of different sizes. The most frequently used saw blades include those with a diameter of 800 mm and with a diameter of 1200 mm. When the smaller saw blades (800 mm) are used, the wall saws are operated in a first transmission stage whereas when the larger saw blades (1200 mm) are used, the wall saws are operated in a second transmission stage, whereby the first transmission stage has a smaller transmission ratio than the second transmission stage.

### SUMMARY OF THE INVENTION

The use of mechanical switching devices for wall saws has the drawback that the operator has to at least partially dismantle the wall saw in order to actuate the switching device. The saw blade and the guard surrounding the saw blade hinder access to the mechanical switching device and so they have to be dismantled. When changing to a saw blade of a different size, the operator has to remember to actuate the mechanical switching device and to set the transmission stage that corresponds to the size of the saw blade. Even in those cases when the mechanical switching device is accessible with the saw blade and the saw blade guard in their installed state, switching between the first and second transmission stages is very time-consuming. In the case of wall saws, for safety reasons, the operator has to leave the working area during the sawing operation. The operator cannot switch between the first and second transmission stages while the wall saw is active, but rather, the operator has to stop the wall saw, enter the working area, actuate the mechanical switching device, leave the working area and switch the wall saw back on.

It is an object of the present invention to provide a device for switching between a first and a second transmission stage to be used for machine tools, whereby the switching between a first and a second transmission stage is configured to be as simple as possible for the operator. In the case of machine tools mounted on rails or stands, the operator should not have to enter the working area of the machine tool in order to be able to switch between the first and second transmission stages.

The present invention provides a machine tool including:
a drive unit with a drive motor and a drive shaft that can be rotated around a drive axis of rotation by the drive motor in a forward direction as well as in a reverse direction opposite to the forward direction,
a driven unit with a driven shaft that can be non-rotatably connected to a processing tool and that can be rotated in a direction of rotation around a driven axis of rotation,
a planetary gear train arranged between the drive shaft and the driven shaft, comprising several components configured as a sun gear, a carrier, a planet gear and an annular gear, whereby the drive shaft is non-rotatably coupled to a first planetary gear component, and
a device for switching between a first transmission stage of the planetary gear train—formed between the first and a second planetary gear component—and a second transmission stage of the planetary gear train—formed between the first and a third planetary gear component—encompassing

a first blocking means that is coupled to the second planetary gear component and that blocks the movement of the second planetary gear component in the reverse direction,

a second blocking means that is coupled to the third planetary gear component and that blocks the movement of the third planetary gear component in the reverse direction, and

a device that transmits the torque to the driven shaft and that is coupled to the second and third planetary gear components, whereby this device non-rotatably connects the second planetary gear component to the driven shaft when the drive motor is running in the forward direction, and non-rotatably connects the third planetary gear component to the driven shaft when the drive motor is running in the reverse direction.

Switching between the first and second transmission stages of the planetary gear train is done by means of the torque-transmission device by changing the direction of rotation of the drive motor. If the drive motor is rotating around the drive axis of rotation in the forward direction, the second planetary gear component is non-rotatably connected to the driven shaft. If the drive motor is rotating around the drive axis of rotation in the reverse direction, the third planetary gear component is non-rotatably connected to the driven shaft. This type of switching is suitable for machine tools in which the processing tool is driven in only one direction of rotation. The operator can switch the transmission ratio between a first and a second transmission stage using an operating unit by changing the direction of rotation of the drive motor.

In the planetary gear train, any of its components can be non-rotatably connected to the drive shaft. The planetary gear component that is non-rotatably connected to the drive shaft is referred to as the first planetary gear component. Among the remaining planetary gear components, two of them can be non-rotatably connected to the driven shaft by means of the switching device. The two planetary gear components that can be non-rotatably connected to the driven shaft are referred to as the second and third planetary gear components. In this context, the second planetary gear component, together with the first planetary gear component, forms the first transmission stage of the planetary gear train, while the third planetary gear component, together with the first planetary gear component, forms the second transmission stage of the planetary gear train.

In a first embodiment, the device that transmits the torque to the driven shaft has a first catch mechanism and a second catch mechanism. Here, the first catch mechanism is preferably arranged between the driven shaft and the second planetary gear component, while the second catch mechanism is arranged between the driven shaft and the third planetary gear component. The first catch mechanism is arranged between the driven shaft and the second planetary gear component and it transmits the torque to the driven shaft in the forward direction. When the second planetary gear component is rotated in the reverse direction, no torque is transmitted to the driven shaft and the second planetary gear component freewheels. The second catch mechanism is arranged between the driven shaft and the third planetary gear component and it transmits the torque to the driven shaft in the forward direction. When the third planetary gear component is rotated in the reverse direction, no torque is transmitted to the driven shaft and the third planetary gear component freewheels.

In a second embodiment, the device that transmits the torque to the driven shaft has a centrifugal switch. A centrifugal switch entails the advantage that switching between the first and second transmission stages of the planetary gear train is done as a function of the rotational speed. The switching speed of the centrifugal switch is defined as the rotational speed at which the centrifugal forces of the centrifugal weights compensate for the recovery force of a latching element.

The centrifugal switch preferably has a first centrifugal weight and a second centrifugal weight, whereby the first centrifugal weight is connected to the second planetary gear component, while the second centrifugal weight is connected to the third planetary gear component. The centrifugal switch preferably has a sliding collar having a first and second latching opening as well as a latching element, whereby the sliding collar is mounted so that it can move along the driven axis of rotation. At a low rotational speed of the drive motor, the centrifugal forces of the centrifugal weights resulting from the rotational movement are smaller than the pre-tensioning force of the latching element. If the rotational speed of the drive motor is increased, the centrifugal forces of the centrifugal weights exceed the pre-tensioning force of the latching element and the sliding collar is moved along the driven axis of rotation between a first and a second end position.

Particularly in the case of a machine tool having a centrifugal switch, a method for switching between a first and a second transmission stage of a planetary gear train comprises the following steps:
the rotational speed of the drive motor is reduced to below the switching speed of the centrifugal switch,
the direction of rotation of the drive motor is switched from one direction of rotation to the opposite direction of rotation, and
the rotational speed of the drive motor is increased to above the switching speed of the centrifugal switch.

Embodiments of the invention will be described below with reference to the drawing. The drawing does not necessarily depict the embodiments true-to-scale, but rather, the drawing—where necessary for the sake of elucidation—is shown in schematic and/or slightly distorted form. Regarding any additions to the teaching that can be gleaned directly from the drawing, reference is hereby made to the pertinent state of the art. Here, it should be kept in mind that many modifications and changes relating to the shape and to details of an embodiment can be made without departing from the general idea of the invention. The features of the invention disclosed in the description, in the drawing as well as in the claims can be essential for the refinement of the invention, either individually or in any desired combination. Moreover, all combinations of at least two of the features disclosed in the description, in the drawing and/or in the claims fall within the scope of the invention. The general idea of the invention is not limited to the exact form or detail of the preferred embodiment shown and described below nor is it limited to a subject matter that would be limited in comparison to the subject matter put forward in the claims. At given rated ranges, values that fall within the specified limits are also disclosed as limit values and can be used and claimed as desired. For the sake of clarity, identical or similar parts or else parts with an identical or similar function are designated by the same reference numerals below.

### BRIEF DESCRIPTION OF THE DRAWINGS

The following is shown:

FIG. 1: a machine tool according to the invention, having a drive unit, a driven unit, a gear assembly with a planetary gear train and a device for switching between a first and a second transmission stage by reversing the direction of rotation of the drive unit;

FIGS. 2A,B: a first embodiment of the device for switching between a first and a second transmission stage in a three-dimensional view (FIG. 2A) as well as in a lengthwise view along the drive and driven shafts (FIG. 2B);

FIGS. 3A,B: in a schematic depiction, the switching device of FIGS. 2A,B in the first transmission stage in which the drive unit runs clockwise around the drive axis of rotation (FIG. 3A), and in the second transmission stage in which the drive unit runs counterclockwise around the drive axis of rotation (FIG. 3B); and

FIGS. 4A,B: a second embodiment of the device for switching between a first and a second transmission stage in a three-dimensional view (FIG. 4A) as well as in a lengthwise view along the drive and driven shafts (FIG. 4B).

### DETAILED DESCRIPTION

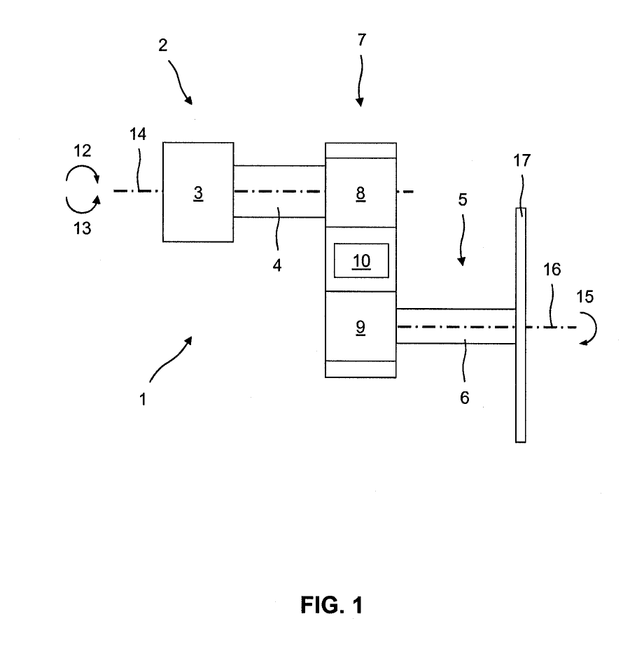

FIG. 1 shows a schematic view of a machine tool 1 according to the invention. The machine tool is configured, for example, as a wall saw, a coring tool, a hammer drill or any other machine tool in which the processing tool is moved in only one direction.

The machine tool 1 comprises a drive unit 2 with a drive motor 3 and a drive shaft 4, a driven unit 5 with a driven shaft 6, a gear assembly 7 with a planetary gear train 8 and an additional gear unit 9 as well as a device 10 for switching between a first and a second transmission stage of the planetary gear train 8. The additional gear unit 9 is employed, for instance, when the drive shaft 4 and the driven shaft 6 are not supposed to be arranged coaxially with respect to each other. In this case, the driven shaft 6 can be offset parallel to the drive shaft 4, for example, by means of a spur gear system.

The drive shaft 4 is configured so that it can be rotated by the drive motor 3 around the drive axis of rotation 14 in a forward direction 12 and in a reverse direction 13. The clockwise direction of rotation is defined as the forward direction 12, while the counterclockwise direction of rotation is defined as the reverse direction 13. The driven shaft 6 is rotated around the driven axis of rotation 15 in the same direction of movement, independently of the direction of rotation 12, 13 of the drive shaft 4. In the configuration shown in FIG. 1, the direction of movement of the drive shaft 4 corresponds to the forward direction 12. Mounted on the driven shaft 16 is a processing tool 16 that can be non-rotatably connected to the driven shaft 6. The processing tool 16 is always rotated in the same direction of movement 12, irrespective of the direction of rotation 12, 13 of the drive motor 3.

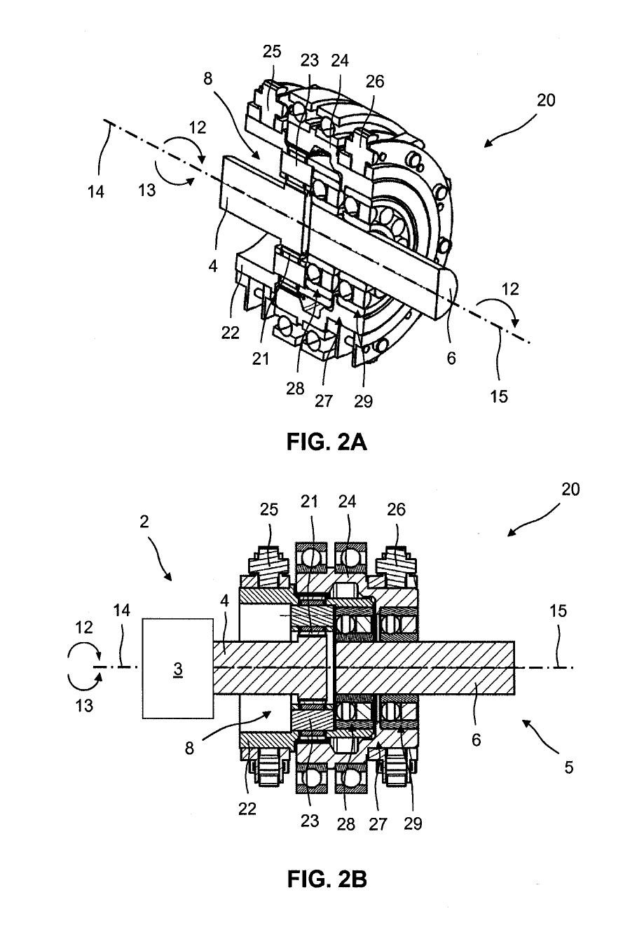

FIGS. 2A, B show a first embodiment of the device 20 for switching between a first and a second transmission stage of the planetary gear train 8 on the basis of the two directions of rotation 12, 13 of the drive unit 2. In this context, FIG. 2A shows the switching device 20 in a three-dimensional view while FIG. 2B shows the switching device 20 in a lengthwise view along the drive shaft and driven shafts 4, 6, which, in the embodiment shown, are arranged coaxially with respect to each other.

The planetary gear train 8 is configured as a single-stage planetary gear train and it encompasses several components which are configured as a sun gear 21, a carrier 22, a planet gear 23 and an annular gear 24. In the embodiment shown, the sun gear 21 is non-rotatably coupled to the drive shaft 4. By means of the switching device 20, the carrier 22 and the annular gear 24 can be connected to the driven shaft 6, whereby only one planetary gear component, either the carrier 22 or the annular gear 24, can be connected to the driven shaft 6; it is not possible to connect the driven shaft 6 to the carrier 22 and to the annular gear 24 simultaneously. In a planetary gear train, each of its components can be non-rotatably connected to the drive shaft 4. Among the remaining planetary gear components, two of them can be non-rotatably connected to the driven shaft 6 by means of the switching device 20. The planetary gear component that is non-rotatably connected to the drive shaft 4 is referred to as the first planetary gear component. The two planetary gear components that can be connected to the driven shaft 6 are referred to as the second and third planetary gear components.

The transmission ratio between the first and the second planetary gear components, that is to say, between the sun gear 21 and the carrier 22, defines the first transmission stage of the planetary gear train 8, while the transmission ratio between the first and the third planetary gear components, that is to say, between the sun gear 21 and the annular gear 24, defines the second transmission stage of the planetary gear train 8. Switching between the first and second transmission stages is accomplished by means of the switching device 20 on the basis of the two directions of rotation 12, 13 of the drive motor 3. When the drive motor 3 is running in the forward direction 12, the first transmission stage of the planetary gear train 8 is active, whereas, when the drive motor 3 is running in the reverse direction 13, the second transmission stage of the planetary gear train 8 is active.

The switching device 20 comprises a first blocking means 25, a second blocking means 26 and a device 27 that transmits the torque to the driven shaft 6. The term “blocking means” refers to a component that blocks a rotational movement in a first direction of rotation and permits it in a second direction of rotation. The first and second blocking means 25, 26 are configured, for instance, as a freewheel or as a pawl. The first blocking means 25 is coupled to the second planetary gear component, namely, the carrier 22, and it blocks the rotation of the carrier 22 in the reverse direction 13, that is to say, the carrier 22 is configured so that it can rotate in the forward direction 12 but cannot rotate in the reverse direction 13. The second blocking means 26 is coupled to the third planetary gear component, namely, the annular gear 24, and it blocks the rotation of the annular gear 24 in the reverse direction 13, that is to say, the annular gear 24 is configured so that it can rotate in the forward direction 12 but cannot rotate in the reverse direction 13.

In the embodiment shown in FIGS. 2A,B, the device 27 comprises a first catch mechanism 28 and a second catch mechanism 29. The term “catch mechanism” refers to a component that transmits a rotational movement in a first direction of rotation and that freewheels in a second direction of rotation. The first catch mechanism 28 is arranged between the carrier 22 and the driven shaft 6, and it transmits the torque of the carrier 22 to the driven shaft 6 in the forward direction 12. When the carrier 22 is rotating in the reverse direction 13, no torque is transmitted from the carrier 22 to the driven shaft 6, and the carrier 22 freewheels. The second catch mechanism 29 is arranged between the annular gear 24 and the driven shaft 6, and it transmits the torque of the annular gear 24 to the driven shaft 6 in the forward direction 12. When the annular gear 24 is rotating in the reverse direction 13, no torque is transmitted from the annular gear 24 to the driven shaft 6, and the annular gear 24 freewheels.

The switching device 20 is arranged between the drive shaft 4—which is driven by the drive motor 3—and the driven shaft 6—which rotates the processing tool 16 around the driven axis of rotation 15. As an alternative, the switching device according to the invention can constitute a planetary gear stage in a multi-stage planetary gear train, whereby the switching device can be employed as the first, the middle or the last planetary gear stage. Moreover, additional gear components such as a slip clutch or a spur gear system, can be interconnected. These additional gear components do not have any influence on the idea of the invention, namely, implementing the switching between a first and a second transmission stage on the basis of the direction of rotation of a drive unit. FIGS. 2A,B show an embodiment in which the sun gear 21 is non-rotatably coupled to the drive shaft 4, and the blocking means and the catch mechanisms 25, 26, 28, 29 are coupled to the carrier 22 and to the annular gear 24. As a matter of principle, any of the components of a planetary gear train 8 can be non-rotatably coupled. The blocking means and the catch mechanisms are coupled to the additional planetary gear components and they control the transmission of torque in one direction and prevent it in the other direction.

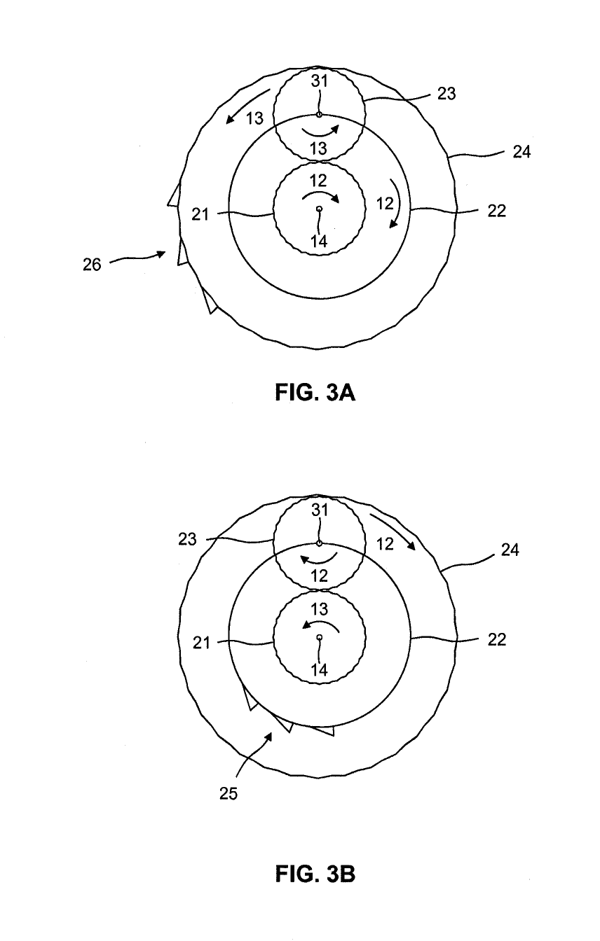

FIGS. 3A,B show the switching device 20 of FIGS. 2A,B in the first transmission stage in which the drive shaft 4 is driven by the drive motor 3 in the forward direction 12 around the driving axis 14 (FIG. 3A), and in the second transmission stage in which the driven shaft 4 is driven by the drive motor 3 in the reverse direction 13 around the drive axis of rotation 14 (FIG. 3B).

In the first transmission stage shown in FIG. 3A, the drive shaft 4 is driven by the drive motor 3 in the forward direction 12 around the drive axis of rotation 14. The torque of the drive shaft 4 is transmitted by means of the non-rotatably connected sun gear 21 to the planet gears 23 which, in the first transmission stage, rotate in the reverse direction 13 around an axis of rotation 31 and which roll in the annular gear 24 in the reverse direction 13. Since the rotation of the annular gear 24 in the reverse direction 13 is blocked by the second blocking means 26 and since the planet gears 23 are mounted in the carrier 22, the torque is transmitted from the planet gears 23 to the carrier 22 which rotates in the forward direction 12. The carrier 22 is coupled to the driven shaft 6 via the first catch mechanism 28, whereby the first catch mechanism 28 transmits the torque to the driven shaft 6 in the forward direction 12 and freewheels in the reverse direction 13. The torque is transmitted via the first catch mechanism 28 from the carrier 22 to the driven shaft 6 which rotates together with the processing tool 16 in the forward direction 12.

In the second transmission stage shown in FIG. 3B, the driven shaft 4 is driven in the reverse direction 13 around the drive axis of rotation 14. The torque of the drive shaft 4 is transmitted via the non-rotatably connected sun gear 21 to the planet gears 23 which, in the second transmission stage, rotate in the forward direction 12 around their axis of rotation 31. The planet gears 23 tend to roll in the reverse direction 13 in the annular gear 24. Since the rotation of the carrier 22 in which the planet gears 23 are mounted is blocked in the reverse direction 13 by the first blocking means 25, the carrier 22 stands still and the torque is transmitted from the planet gears 23 to the annular gear 24 which rotates in the forward direction 12. The annular gear 24 is coupled via the second catch mechanism 29 to the driven shaft 6, whereby the second catch mechanism 29 transmits the torque to the driven shaft 6 in the forward direction 12 and freewheels in the reverse direction 13. The torque is transmitted via the second catch mechanism 29 from the annular gear 24 to the driven shaft 6 which rotates together with the processing tool 16 in the forward direction 12.

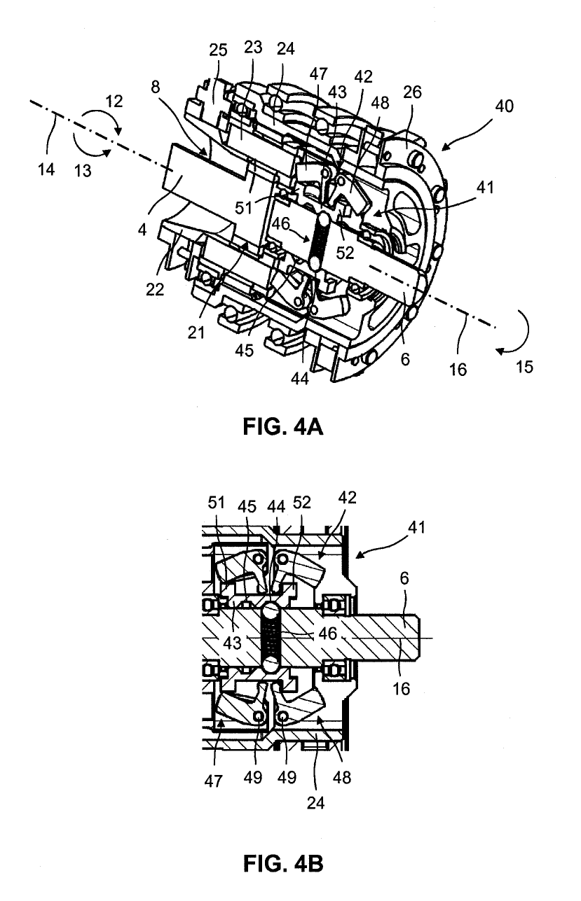

FIGS. 4A,B show a second embodiment of the device 40 for switching between the first and second transmission stages of the planetary gear train 8 on the basis of the two directions of rotation 12, 13 of the drive unit 2. Here, FIG. 4A shows the switching device 40 in a three-dimensional view, while FIG. 4B shows in detail the switching device 10 in a lengthwise view along the drive and driven shafts 4, 6, respectively.

The switching device 40 differs from the switching device 20 in terms of the structure of the device that transmits the torque to the driven shaft 6. The switching device 40 comprises the first blocking means 25, the second blocking means 26 and a torque-transmission device 41 that is configured as a centrifugal switch 42. The first blocking means 25 is coupled to the carrier 22 and it blocks the rotation of the planet gear 22 in the reverse direction 13. The second blocking means 26 is coupled to the annular gear 24 and it blocks the rotation of the annular gear 24 in the reverse direction 13.

The centrifugal switch 42 comprises a sliding collar 43 having a first and second latching opening 44, 45 and a latching element 46 that can engage into the latching openings 44, 45 and that is pre-tensioned, for example, by means of a spring, as well as a first and second centrifugal weight 47, 48. The first centrifugal weight 47 is connected to the carrier 22, while the second centrifugal weight 48 is connected to the annular gear 24. The centrifugal weights 47, 48 are mounted so as to be rotatable around an axis of rotation 49. At a low rotational speed n of the drive motor 3, the centrifugal forces of the centrifugal weights 47, 48 resulting from the rotational movement are smaller than the pre-tensioning force of the latching element 46. If the rotational speed of the drive motor 3 is increased, at a first switching point, the centrifugal forces compensate for the pre-tensioning force and, as the rotational speed of the drive motor 3 is increased further, the centrifugal forces of the centrifugal weights 47, 48 exceed the pre-tensioning force of the latching element 46. The rotational speed n of the drive motor 3 at which the centrifugal forces of the centrifugal weights 47, 48 compensate for the pre-tensioning force of the latching element 46 is referred to as the switch rotational speed nₛ.

The sliding collar 43 surrounds the driven shaft 6 and is mounted so as to be movable along the driven axis of rotation 16 between a first and a second end position, whereby the movement between the end positions is effectuated by means of the centrifugal weights 47, 48. The end faces of the sliding collar 43 have first and second end-face elements 51, 52, whereby, in the first transmission stage, the first end-face elements 51 can engage into recesses in the carrier 22 (first end position) while, in the second transmission stage, the second end-face elements 52 can engage into recesses in the annular gear 24 (second end position). FIG. 4B shows the centrifugal switch 42 in the first transmission stage of the planetary gear train 8, in which the driven shaft 6 is non-rotatably connected to the carrier 22 via the centrifugal switch 42. The first end-face elements 51 engage into the recesses in the carrier 22 (first end position of the sliding collar 43).

In order to switch the planetary gear train 8 from the first transmission stage over to the second transmission stage, the rotational speed of the drive motor 3 is reduced to below the switching speed nₛ. The direction of rotation of the drive motor 3 is switched from the forward direction 12 over to the reverse direction 13, and subsequently the rotational speed n of the drive motor 3 is increased. Once the rotational speed of the drive motor 3 has exceeded the switching speed nₛ, the centrifugal weights 47, 48 move outwards owing to the centrifugal forces caused by the rotation around their axes of rotation 49. The second centrifugal weight 48 is in contact with the second end-face elements 52 of the sliding collar 43 and moves the sliding collar 43 out of the first end position into the second end position in which the second end-face elements 52 of the sliding collar 43 engage into the recesses in the annular gear 24. The annular gear 24 is coupled to the sliding collar 43 by means of the driven shaft 6.

What is claimed is:

1-7. (canceled)

8. A machine tool comprising:
a drive unit with a drive motor and a drive shaft rotatable around a drive axis of rotation by the drive motor in a forward direction as well as in a reverse direction opposite to the forward direction;
a driven unit with a driven shaft non-rotatably connectable to a processing tool and rotatable in a direction of rotation around a driven axis of rotation;
a planetary gear train arranged between the drive shaft and the driven shaft, comprising planetary gear components including a sun gear, a carrier, a planet gear and an annular gear, the drive shaft being non-rotatably coupled to a first of the planetary gear components, and
a switch device for switching between a first transmission stage of the planetary gear train formed between the first and a second of the planetary gear components and a second transmission stage of the planetary gear train formed between the first and a third of the planetary gear components including:
a first blocking device coupled to the second planetary gear component and blocking movement of the second planetary gear component in the reverse direction;
a second blocking device coupled to the third planetary gear component and blocking movement of the third planetary gear component in the reverse direction; and
a transmission device transmitting torque to the driven shaft and coupled to the second and third planetary gear components, the transmission device non-rotatably connecting the second planetary gear component to the driven shaft when the drive motor is running in the forward direction, and non-rotatably connecting the third planetary gear component to the driven shaft when the drive motor is running in the reverse direction.

9. The machine tool as recited in claim 8 wherein the transmission device includes a first catch mechanism and a second catch mechanism.

10. The machine tool as recited in claim 9 wherein the first catch mechanism is arranged between the driven shaft and the second planetary gear component, while the second catch mechanism is arranged between the driven shaft and the third planetary gear component.

11. The machine tool as recited in claim 8 wherein the transmission device includes a centrifugal switch.

12. The machine tool as recited in claim 11 wherein the centrifugal switch includes a first centrifugal weight and a second centrifugal weight, the first centrifugal weight being connected to the second planetary gear component, the second centrifugal weight being connected to the third planetary gear component.

13. The machine tool as recited in claim 12 wherein the centrifugal switch includes a sliding collar having a first and second latching opening and a latching element, the sliding collar mounted movably along the driven axis of rotation.

14. The machine tool as recited in claim 11 wherein the centrifugal switch includes a sliding collar having a first and second latching opening and a latching element, the sliding collar mounted movably along the driven axis of rotation.

15. A method for switching between a first and a second transmission stage of a planetary gear train via a centrifugal switch for a machine tool as recited in claim 11, comprising the following steps:
reducing a rotational speed of the drive motor to below a switching speed of the centrifugal switch;
switching the direction of rotation of the drive motor from one direction of rotation to the opposite direction of rotation; and
increasing the rotational speed of the drive motor to above the switching speed of the centrifugal switch.
